(19) United States
(12) Patent Application Publication
(10) Pub. No.: US 2013/0112177 A1
(43) Pub. Date: May 9, 2013

(54) Miami max II compact fuel vaporizer

(71) Applicants: Adam Stefan Kasprzak, Islamorada, FL (US); Chris Kruszelnicki, Tavernier, FL (US)

(72) Inventors: Adam Stefan Kasprzak, Islamorada, FL (US); Chris Kruszelnicki, Tavernier, FL (US)

(21) Appl. No.: 13/385,629

(22) Filed: Feb. 27, 2012

Related U.S. Application Data
(60) Provisional application No. 61/628,615, filed on Nov. 3, 2011.

(51) Int. Cl. F02M 31/18

(52) U.S. Cl. 123/557

(57) ABSTRACT

Presented vaporizer is a hollow container that houses a circular metallic coil. The coil has an inlet and outlet. The container has one opening serving inlet/outlet as one. This apparatus is designated for the use with internal combustion engines. The engine's coolant is admitted to the container, while fuel passes through the metallic coil located inside the container. After initial start of the engine we witnessed rise of temperature of the engine coolant and in effect expansion of the fuel passing though the coil. Doing so, the pressure in the fuel line increases significantly. In effect the fixed speed setting for fuel pump could be reduced. Flow of the fuel through the fuel vaporizer is administrated by the mean of motor speed control switch connected to the fuel pump. In summary, this device vaporizes petroleum fuel—each in effect dramatically increased efficiency and effectively reduced the emission of CO2.

### SUMMARY OF INVENTION

This invention relates to a means for a process of conditioning gasoline or other liquid automotive fuel before reaches the rail distributing fuel to injectors for combustible engine. Presented is a model of the most compact device for a simple and easy operation on most of automobiles operated by fuel-injected system. A primary objection of the present invention or the specific embodiments is to provide portable, compacted unit capable of reduced the original fuel consumption in most of the vehicles used today.

Compact fuel vaporizer, together with the use of heat exchange coolant system apparatus would significantly improve efficiency of any combustions engines, an specially older and used vehicles that have relatively large fuel consumption ratio.

This invention is the most effective and safe method of fuel efficiency apparatus presented to the industry of combustible engines today, diesel and gasoline alike.

The efficiency of “COMPACT FUEL VAPORIZER” relies on the principle of maximum expansion of the fuel before it reached the injectors of the engine.

Fuel savers and different kind of exchangers for combustible engines have been presented in the past and have been designed in more sophisticated, more complex and in more presented over here expensive envelope all together. In addition to a compact and simple body apparatus, this invention employed a speed motor control switch FIG. 3 designated for controlled administration of the flow of the fuel delivered to the injector's rail. Conjunctions and fine-tuning of those two devices provide significant and effective petroleum saving in today's economy.

Presented invention is build entirely in brass and copper. Best however material, would be without a doubt a corrosive resistance, stainless steel of high grade.

### BRIEF DESCRIPTION OF DRAWINGS

FIG. 1 is a cross illustration of complete assembly of presented invention

FIG. 2 is a cross plan view of presented invention

FIG. 3 is a typical layout of electrical connection for fuel pump in presented invention

FIG. 4 is a typical layout of fuel 6 and cooling 4,5 lines connections in combustible engine equipped with presented invention.

Included photograph 5,6 & 7 represents “compact fuel vaporizer” currently installed on—owned by the inventor, 2002 Chevy Avalanche.

### DETAILED DESCRIPTION OF INVENTION AS DEPICTED IN DRAWINGS

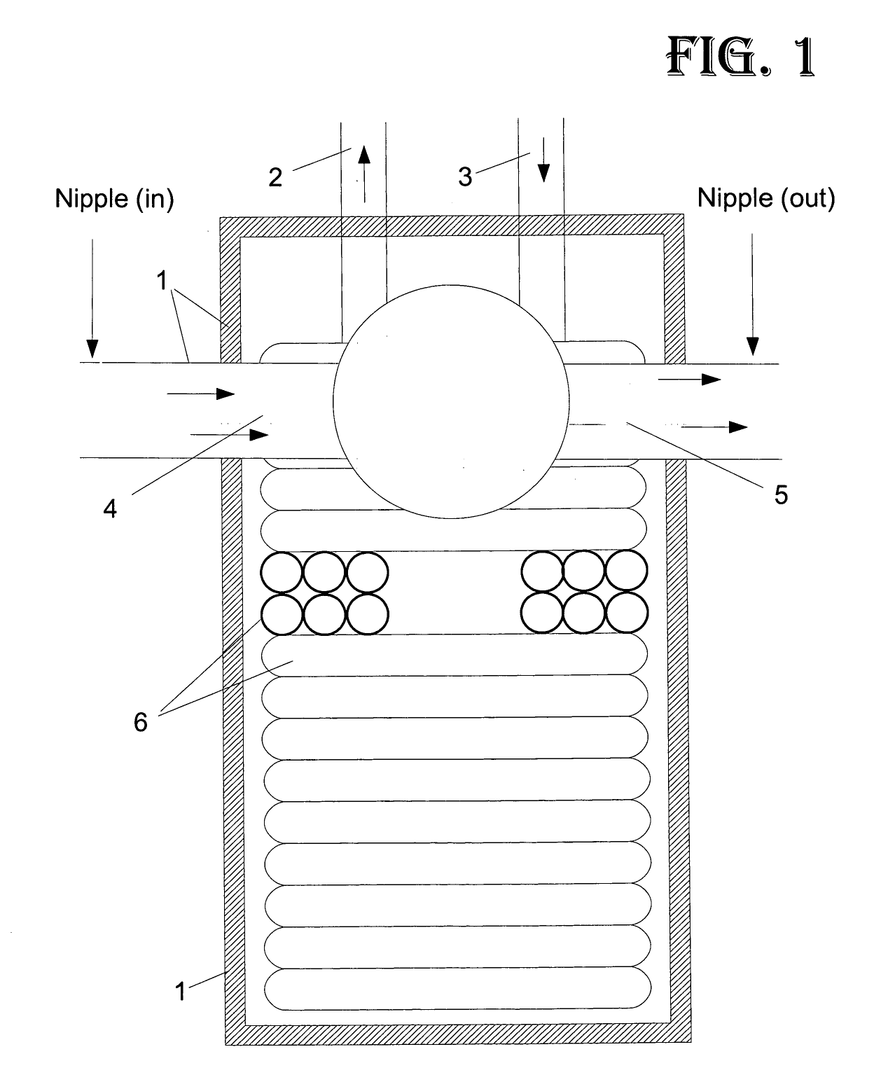

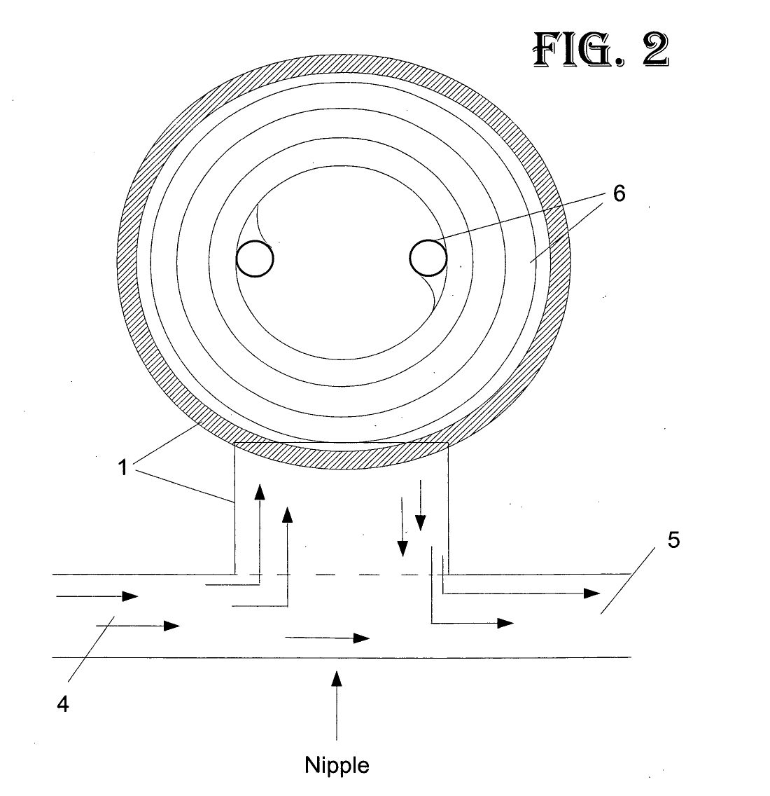

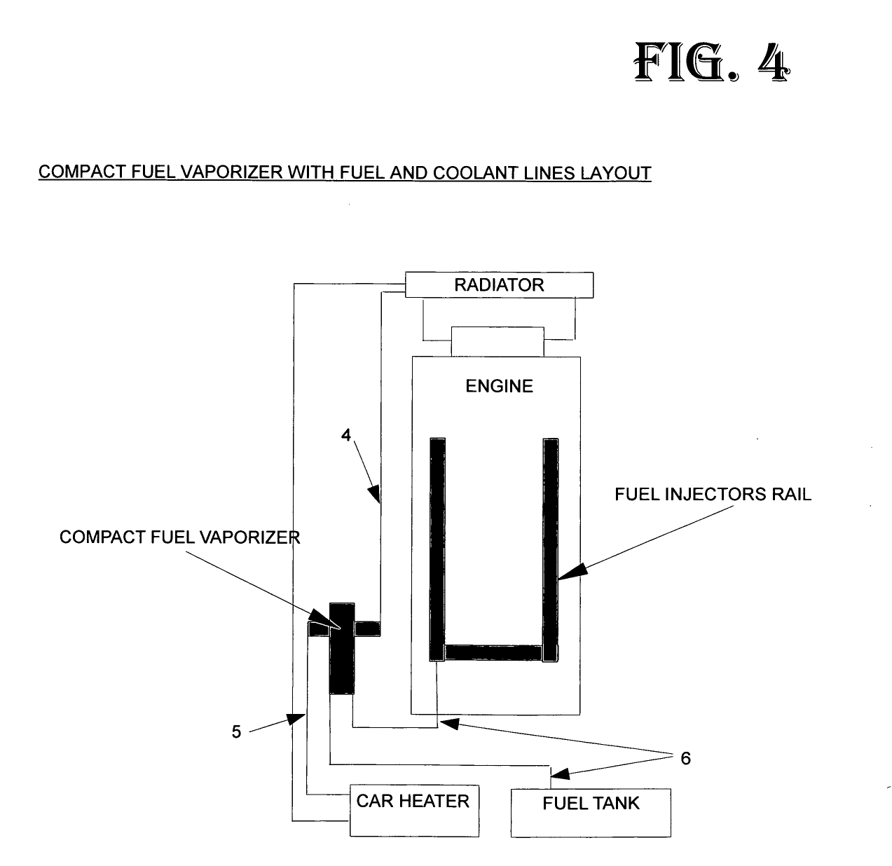

With particular reference to FIGS. 1 and 2 there is illustrated schematic in cross-section of complete invention of compact fuel vaporizer. In the most simplified embodiment having closed liquid coolant circuit and the fuel delivery system combined in one unit together. How it works? After initial start of the engine, the coolant liquid 4, 5 in FIG. 1, 2, 4 of the engine and between the radiator and car heater FIG. 4 is moving rapidly fast, transferring the heat throughout of the entire system. At the same time of initial start—up of the engine the fuel is passing through the entire circular metallic coil inserted inside the container 4,5

One of the most important parts about the coil is the fact of significantly reduced size of the fuel line, from the initially originated at the fuel tank three of the eight of the inch ⅜″, to of the eight of the inch ⅛″ of inside diameter or less, depends on the type of the engine. After first few minutes of the initial start-up of the engine the coolant reach the desired, required for normal operation temperature of the engine. Built in, on the side of the container short nipple FIG. 1, 2 allows continuous entry 4 or passing through of the engine coolant 4,5 that completely envelopes the circular fuel coil 6 that is inserted inside the container. After initial start up of the engine we can witness the rise of temperature of the engine coolant and in an effect rapid expansion of the fuel molecules to the point of partial vaporization.

At this moment the pressure in the fuel line increased significantly. To control this pressure and to administrate the flow of the fuel delivery, without any negative effect on the performance of the engine, presented invention employed pump speed control switch.

The flow of the petroleum fuel through the fuel vaporizer is administrated by the mean of motor speed control switch connected directly to the fuel pump FIG. 4, where in this case is located inside the fuel tank.

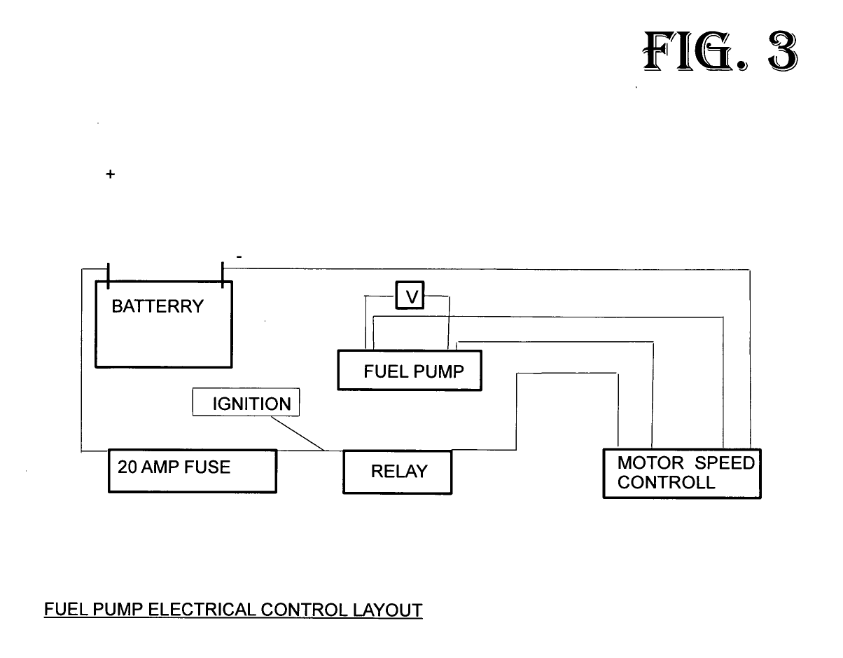

Drawing represent by FIG. 3 is a basic and typical electrical wiring connection for speed control of the fuel pump required for operation of the entire system. The purpose of installed voltmeter FIG. 4 is simply to have visual confirmation and knowledge that the fuel pump located inside the vehicle tank is working properly and without problem.

Drawing in FIG. 4 represents site view of the engine and it's main operational components that works must interact with presented here invention of compact fuel vaporizer. Fuel lines connection, with the starting point at the fuel tank, and ending up on the fuel injectors rail doesn't have any other route to be delivered and has to pass throughout the compact fuel vaporizer. Same principle of passing through liquid fluid is applied for engine coolant when it must continuously travel through between the engine radiator and the car heater. Installed on line compact fuel vaporizer it become a part of the closed system and engine coolant has no other way to reach the car heater—only by passing through the vaporizer.

1. This particular invention is the superior of this characteristic on the market today, when installed on a vehicle will produce substantial increase in efficiency in all motors power by petroleum products, diesel and gasoline alike.
Do to the simple & compact design and the low cost in assembly “compact fuel “vaporizer” could easily be installed on most of the automobiles at any automobile service garage.
Compact Fuel Vaporizer dramatically increased efficiency and effectively reduced the emission of CO2 to the atmosphere.
